(19) United States
(12) Patent Application Publication
(10) Pub. No.: US 2026/0230914 A1
(43) Pub. Date: Aug. 6, 2026

(54) TECHNIQUES FOR INDICATING A QUALITY OF SERVICE FLOW LEVEL CONGESTION AT SERVICE DATA ADAPTATION PROTOCOL SUBLAYER

(71) Applicant: QUALCOMM Incorporated, San Diego, CA (US)

(72) Inventors: Sitaramanjaneyulu KANAMARLAPUDI, San Diego, CA (US); Linhai HE, San Diego, CA (US)

(21) Appl. No.: 19/464,212

(22) Filed: Jan. 29, 2026

Related U.S. Application Data
(60) Provisional application No. 63/753,345, filed on Feb. 3, 2025.

(51) Int. Cl. H04W 28/02

(52) U.S. Cl. CPC H04W 28/0268; H04W 28/0289

(57) ABSTRACT

Certain aspects of the present disclosure provide techniques for wireless communications. An example method includes sending a service data adaptation protocol (SDAP) control protocol data unit (PDU) comprising an indication of a quality of service (QoS) flow level congestion; and communicating with a second wireless communications device in accordance with the indication of the QoS flow level congestion.

### CROSS-REFERENCE TO RELATED APPLICATIONS

This Application claims the benefit of and priority to U.S. Provisional Patent Application No. 63/753,345, filed on Feb. 3, 2025, the entire contents of which are hereby incorporated by reference.

### INTRODUCTION

### Field of the Disclosure

Aspects of the present disclosure relate to wireless communications, and more particularly, to techniques for indicating a quality of service (QoS) flow level congestion at the service data adaptation protocol (SDAP) sublayer.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method of wireless communications by a first wireless communications device. The method includes sending a service data adaptation protocol (SDAP) control protocol data unit (PDU) comprising an indication of a quality of service (QoS) flow level congestion; and communicating with a second wireless communications device in accordance with the indication of the QoS flow level congestion.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example service-based architecture of a core network.

FIG. 6 depicts an example wireless communications system where one or more UEs are engaged in communications of a multi-modal service.

FIG. 7A depicts an example control plane protocol stack.

FIG. 7B depicts an example user plane protocol stack.

FIG. 8 depicts an example structure of a service data adaptation protocol (SDAP) sublayer.

FIG. 9 depicts an example mapping of application flows to logical channel groups for protocol data unit (PDU) sessions.

FIG. 10 depicts a process flow for communications in a network between a first wireless communications device and a second wireless communications device.

FIGS. 11A, 11B, and 11C depict various example aspects of data structures for an SDAP control PDU.

FIG. 12 depicts a method for wireless communications.

FIG. 13 depicts aspects of an example communications device.

### DETAILED DESCRIPTION

Aspects of the present disclosure provide apparatuses, methods, processing systems, and computer-readable mediums for indicating a quality of service (QoS) flow level congestion at the service data adaptation protocol (SDAP) sublayer.

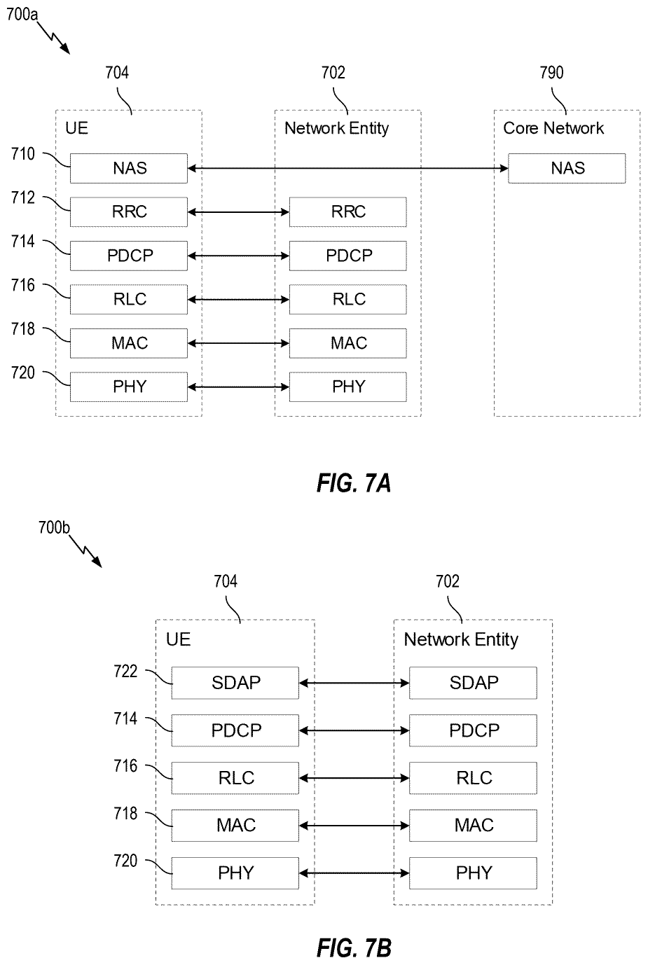

In certain wireless communications systems, such as 5G New Radio (NR) systems and/or future wireless communications technologies, QoS rules define certain characteristics that can be used to group specific traffic flows. Such characteristics may be referred to as QoS characteristics. A traffic flow is a unit of data stream, which may correspond to a protocol data unit (PDU) session. For example, a data stream associated with a particular application, user equipment (UE), or layer may be referred to as a traffic flow. A PDU session refers to a connection that allows a wireless communications device, such as a UE, to access a network. For example, a PDU session may be a logical connection between the UE and a core network such as a 5G core. A PDU is a unit of information at a specific protocol layer of a protocol stack. For example, data may be received from a higher protocol layer, and the data may be encapsulated in a PDU and provided to a lower layer. Such a protocol stack is described further herein with reference to, for example, FIGS. 7A and 7B.

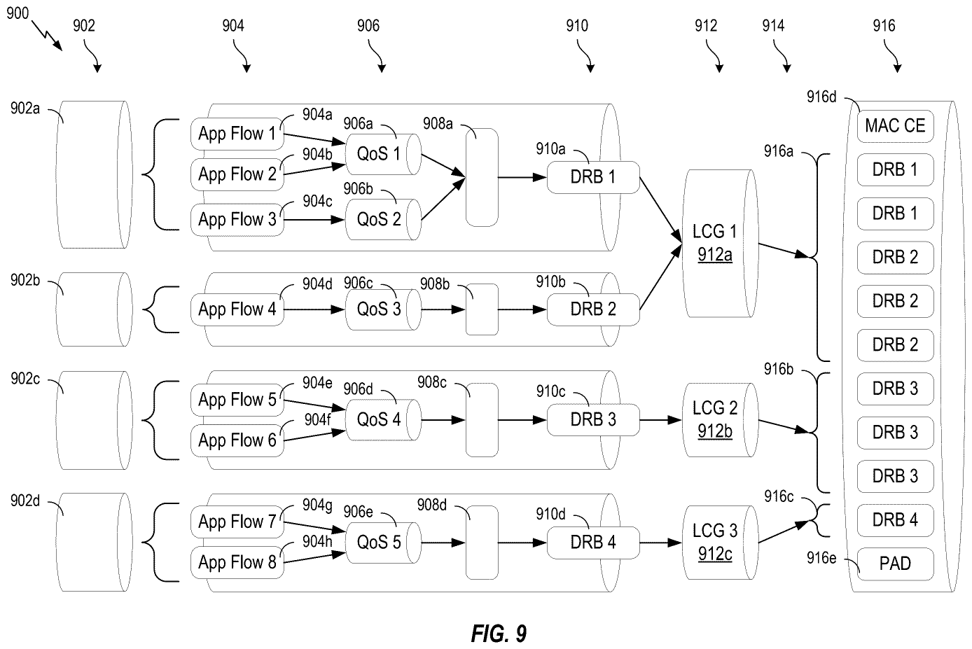

As an example, the traffic flow may include an application flow, such as a data stream generated by an application. An application flow (or multiple application flows) may be mapped to a QoS flow. For example, an application flow that is to use one or more specific criteria defined by one or more QoS rules (e.g., QoS characteristics) may be mapped under one QoS flow. A QoS flow may be identified with a QoS flow identifier (QFI). In certain wireless communications systems, a QoS flow is the logical entity for a specific data stream for differential treatment in terms of QoS characteristics. Non-limiting examples of the QoS characteristics may include an average bit rate, a packet error rate, a packet latency, a guaranteed bit rate, etc. The mapping from an application flow to a QoS flow is described further herein with reference to, for example, FIG. 9.

Different QFIs identify different QoS flows, where a QoS flow is associated with certain QoS characteristics (e.g., maximum latency, average bit rate, packet error rate, latency, etc.). For example, certain QoS characteristics may correspond to or be used for certain types of traffic flows (e.g., audio, video, etc.). A traffic flow is mapped to a QoS flow, such that the traffic flow is subject to the QoS characteristics. The traffic flow and/or QoS flow may then be mapped to one or more radio bearers for transmission through the network.

QoS characteristics may help resource management to adjust, for example, grant, radio resources, reliability of a link, etc. to meet throughput, latency, and/or error rate requirement(s). For example, as part of a service level agreement (SLA) agreed for the type of service an application may provide, a network entity or a UE may initiate a QoS configuration as part of PDU session establishment or as part of subsequent reconfiguration procedure(s). Non-limiting examples of the type of service that an application may provide include enhanced mobile broadband (eMBB), extended reality (XR), and gaming. The QoS characteristics may be coordinated at the core network level, such as between various functional components, based on subscription, user profile, and associated radio deployment and policy. The functional components may be referred to as sublayers. The sublayers make up layers, which are structural components of a protocol stack in wireless communications systems. In some cases, a QoS configuration may be based on information available at an application, which may be indicated through proprietary signaling from an application server to a network entity or based on specific detection logics, such as machine learning (ML) based detection logics.

Based on the derived (e.g., obtained or detected) QoS configuration(s) and various types of traffic flows present, a specific set of QoS flows may be mapped to a specific radio bearer. A radio bearer, which is a logical channel established between a UE and the network, may be mapped to a logical channel group (LCG), which may be subject to one or more logical channel prioritization (LCP) rules.

A medium access control (MAC) level LCP, which may be referred to as a MAC LCP, is a procedure which controls how much data is transmitted from which radio bearer for a given grant. Non-limiting examples of the MAC LCP include assigning a prioritized bit rate (PBR), a bucket size duration (BSD), a priority, etc. to an LCG. The MAC LCP is defined at the MAC level based on logical channel (LC) and radio bearer priorities across multiple PDU sessions (e.g., with or without slicing). However, the MAC LCP does not consider QoS characteristics (e.g., at the MAC level). For example, QFI information exists at SDAP level, and a static or dynamic configuration controls QFI to radio bearer mapping. QoS information, such as relating to the QFI information, does not exist at other level(s), such as packet data convergence protocol (PDCP), radio link control (RLC), or MAC levels.

Certain technical challenges exist in processing of application flows. For example, some application flows need very stable throughput and low latency (e.g., for XR or gaming applications). Some rate adaptation logics have been implemented, such as based on radio grant management and associated impact on QoS flows, which can help such applications to adjust the codec to enable better user experience. However, these rate adaptation logics may not consider QFI-specific characteristics during MAC encoding (e.g., for uplink) or scheduling of MAC PDUs (e.g., for downlink). Thus, the user experience for certain applications may still be downgraded (e.g., despite the adjusted application codec), as there is no QoS-specific knowledge at the MAC level due to data arrival pattern or congestion on radio grant level. Accordingly, user experience for certain applications, such as for XR or gaming services, may be impacted due to degradation of various key performance indices (KPIs), such as reduced bit rate and/or increased latency.

Some approaches (e.g., at a radio access network level) seek to improve traffic flow characteristics by, for example, switching a QFI from one radio bearer to another, such as through a reflective QoS (RQoS) mechanism. However, certain technical challenges exist for improving traffic flow characteristics, which may relate to, for example, how a first wireless communications device may indicate, to a second wireless communications device, a QoS flow level congestion. The QoS flow level congestion may be a QoS-flow-specific degradation in one or more KPIs (e.g., not satisfying certain QoS rules relating to bit rate, latency, and/or the like). The indication of a QoS flow level congestion may help to improve the overall scheduling or flow mapping, or other procedures for immediate action to ensure a level of user experience for certain applications.

One approach to solving the technical challenges described above may be to indicate the QoS flow level congestion at MAC level (e.g., via MAC sublayer). However, such an approach may encounter certain technical challenges and complicate the layered system of processing PDU sessions. For example, packets of data within a radio bearer can be of different orders. The different orders of the packets of data within the radio bearer may result in data corresponding to a higher priority flow being behind a large amount of lower priority traffic. While this situation can be partially addressed at the implementation level by, for example, segregating traffic based on priority within a PDCP bearer (e.g., with multiple queues in one radio bearer), this may not resolve the situation described above if the LC priorities are not configured correctly.

Moreover, QoS flow level identification is not present beyond the SDAP level. For example, an SDAP packet (which has a QFI) becomes a payload of the PDCP sublayer, though the SDAP packet is not ciphered. Any information or association of a traffic with a QFI, or statistics or metrics with a QFI, at MAC level may be complex and may need processing by multiple entities (e.g., from SDAP to PDCP, then to RLC, and then to MAC) for every packet of data. This may be a layer violation, and may involve signaling exchange across the layers, causing delays. Furthermore, a MAC control element (CE) at QoS flow level may not address the above technical challenges, as MAC operates at LC and radio bearer levels. These technical challenges are exacerbated when a network entity may be partitioned into a central unit (e.g., for PDCP) and a distributed unit (e.g., for RLC and MAC). For example, the buffering would happen at multiple levels, with the central unit and the distributed unit potentially being located at very different locations (e.g., a cloud-based central unit and a physical distributed unit).

Aspects described herein may overcome the aforementioned technical challenges, for example, by providing an indication of a QoS flow level congestion at the SDAP sublayer. For example, when a specific QoS flow is not meeting a QoS rule (e.g., corresponding to certain QoS characteristic(s) or specification(s)) defined based on scheduling pattern, the PDCP, RLC, and/or MAC sublayers can indicate this to SDAP sublayer. The SDAP sublayer may indicate the QoS flow level congestion for a QFI using SDAP-based signaling. Then, the network can take one or more actions that are in accordance with an accurate indication of a QoS flow level congestion. In some aspects, this SDAP-based signaling can indicate an adjustment to a codec rate for the congested QoS flow (e.g., corresponding to the QoS flow for which the QoS flow level congestion is indicated), such that the network action(s) can be performed based on the indicated adjustment to the codec rate.

Certain techniques for indicating a QoS flow level congestion at the SDAP sublayer described herein may provide various beneficial technical effects and/or advantages. The techniques for indicating a QoS flow level congestion at the SDAP sublayer may enable improved wireless communications performance, such as increased bit rate or throughput and reduced latency. For example, the techniques described herein may improve the user experience for applications that need very stable throughput and low latency, such as XR or gaming applications. As a QoS flow level congestion is indicated through SDAP layer, the techniques described herein can help a radio access network to specifically target a congested QoS flow. For example, the radio access network may perform various actions regarding the congested QoS flow, such as adjusted flow mapping, dynamic grant modification, and/or configuration update (e.g., LC configuration update, radio bearer configuration update, cell mapping update, configured grant update, etc.), which improve the overall QoS flow KPIs and enable enhanced user experience for immersive applications like XR or gaming applications (e.g., based on improved bit rate and/or reduced latency). In some cases, the radio access network may perform such actions based on a codec rate (e.g., an adjustment to the codec rate) indicated for the congested QoS flow, such that the radio access network may accurately address a QoS-flow-specific congestion, resulting in improved bit rate and/or reduced latency. Furthermore, the techniques described herein help to avoid any potential layer violation while processing PDU sessions by limiting the QoS flow-based signaling and management to SDAP layer.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

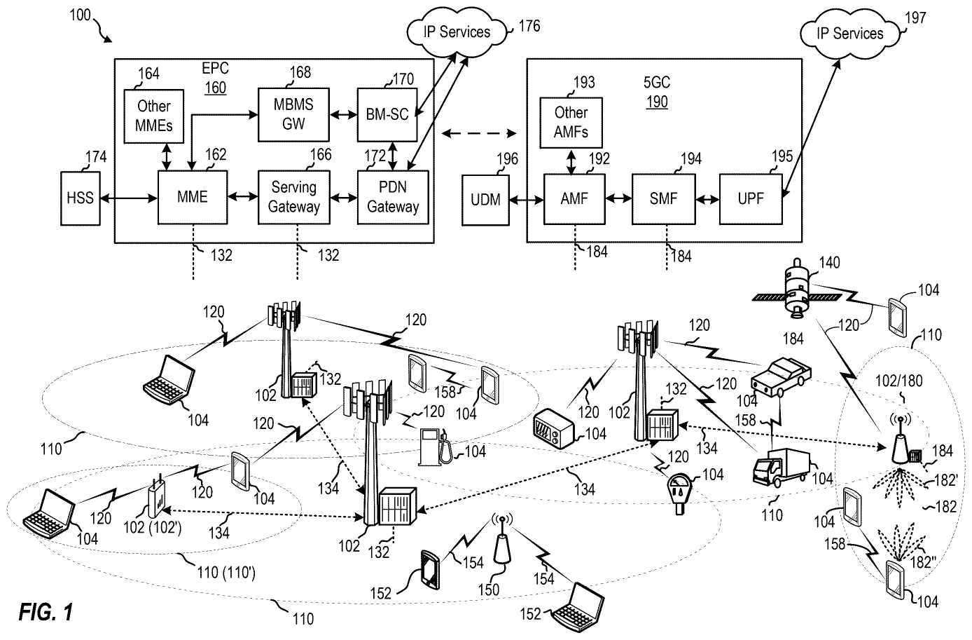

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

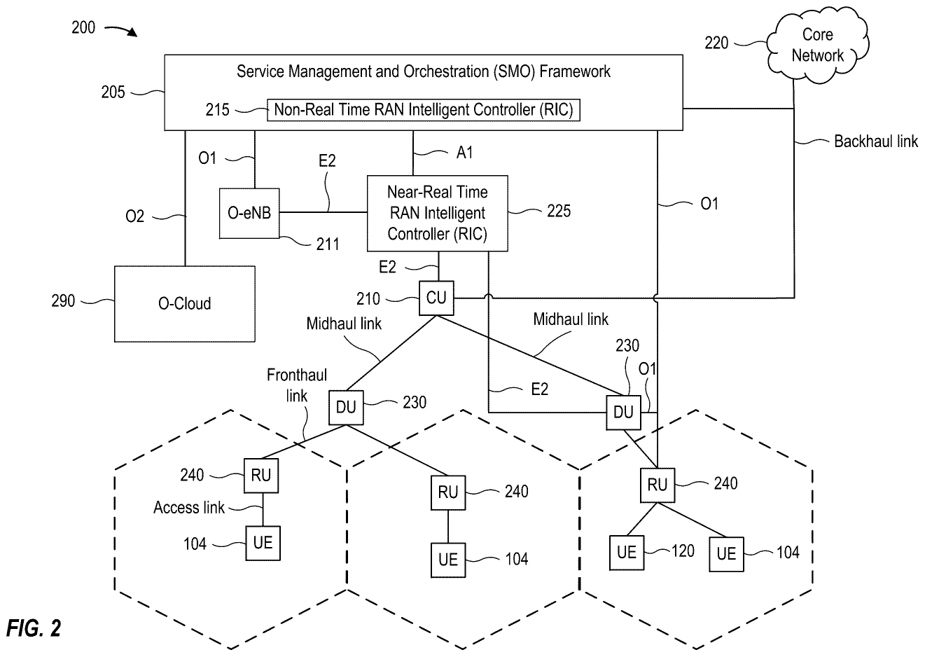

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC network 190 through second backhaul links 184. BSs 102 may communicate directly or indirectly (e.g., through the EPC 160 or the 5GC network 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7,125 MHz, which is often referred to (interchangeably) as “Sub-6 GHz”. Similarly, 3GPP currently defines Frequency Range 2 (FR 2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182′′. UE 104 may also transmit a beamformed signal to the BS 180 in one or more transmit directions 182′′. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a Wi-Fi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC network 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC network 190. AMF 192 provides, for example, quality of service (QoS) flow and session management.

IP packets are transferred through UPF 195, which is connected to the IP Services 197. UPF 195 may provide UE IP address allocation as well as other functions for 5GC network 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

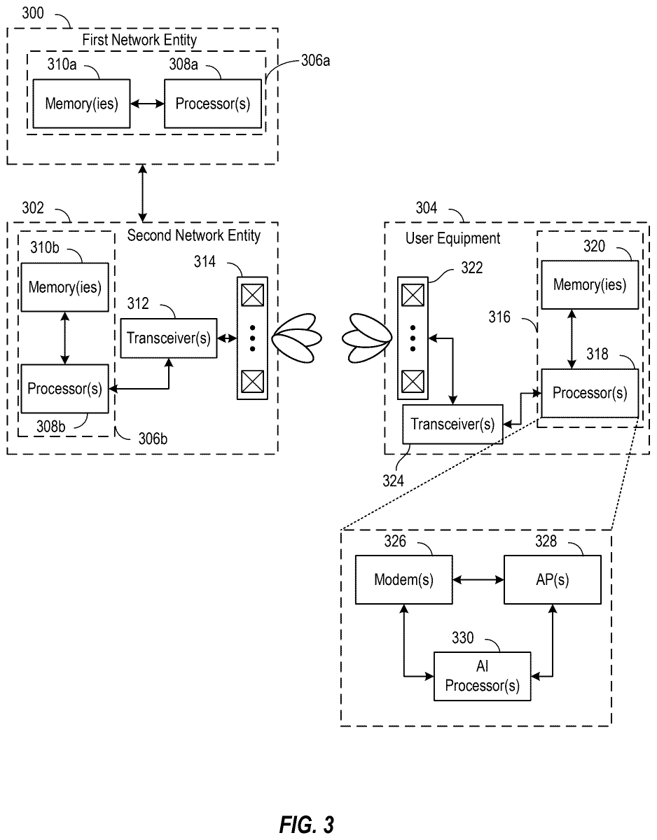

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

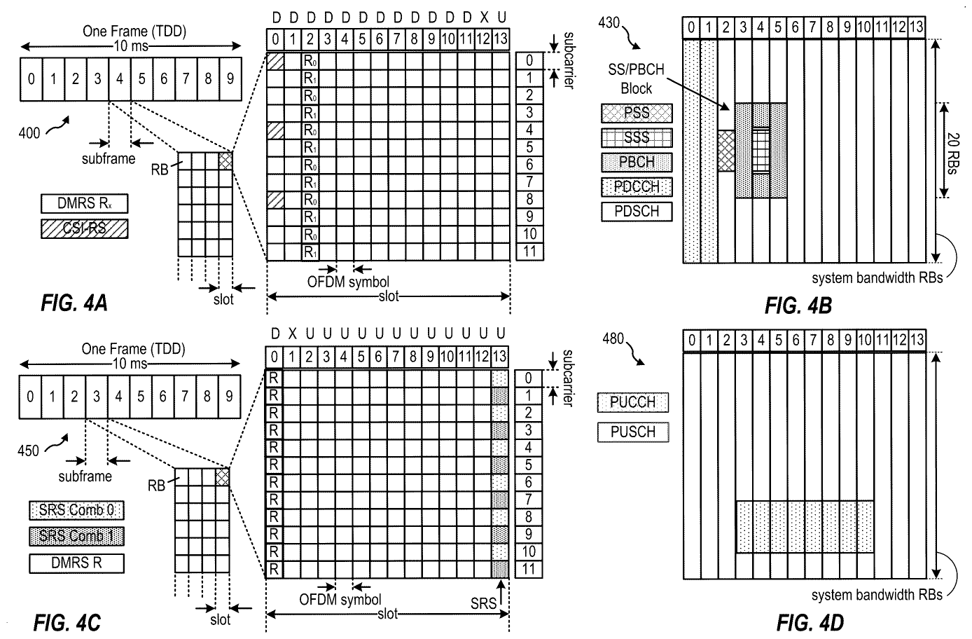

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIG. 1 and UE 304 of FIG. 3). The RS may include a demodulation RS (DMRS) and/or a channel state information reference signal (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., UE 104 of FIG. 1 and UE 304 of FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Core Network Architecture

As described herein, a wireless communications system may include a core network (CN) (e.g., the 5GC network 190) that enables connectivity to a data network (e.g., the internet, an intranet, a private data network, etc.). In some cases, the CN may enable connectivity to application servers, for example, application servers that host video streaming service(s), social media service(s), virtual reality (VR), augmented reality (AR), and/or mixed reality (MR) service(s) (e.g., collectively referred to as extended reality (XR) service(s)), gaming service(s), etc.

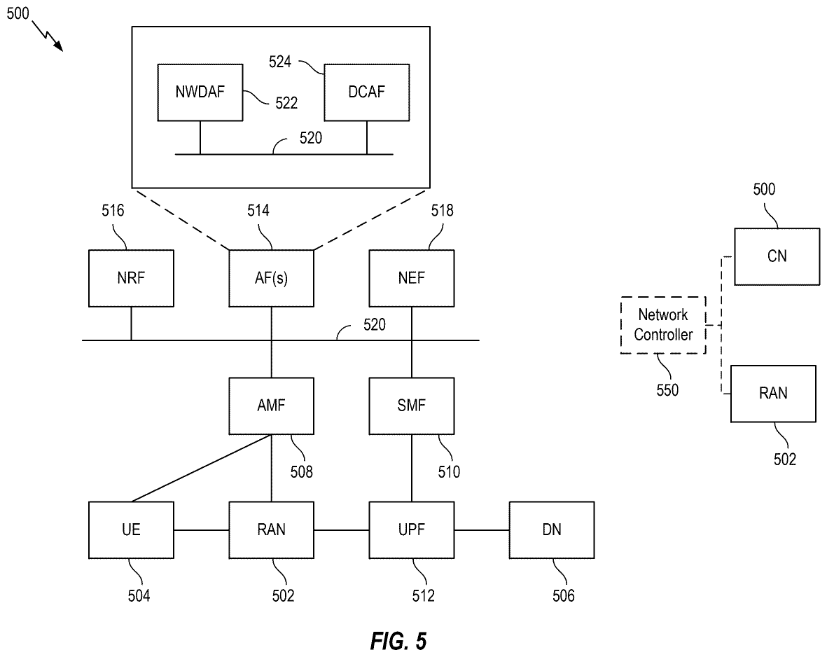

FIG. 5 illustrates an example service-based architecture of a CN 500. In this example, the CN 500 is in communication with a RAN 502 and a UE 504, for example, as described herein with respect to FIG. 1. The CN 500 may facilitate communications between the UE 504 and a data network 506 (illustrated in FIG. 5 as “DN”), which may include, for example, the internet and/or an intranet.

The CN 500 includes an access and mobility management function (AMF) 508, a session management function (SMF) 510, a user plane function (UPF) 512, one or more application functions (AFs) 514, a network repository function (NRF) 516, and a network exposure function (NEF) 518.

In a service-based architecture, network functions of the CN 500 are in communication with each other via a common bus 520. The common bus 520 is used for communicating control plane traffic among the network functions. Control plane traffic may include control signaling such as mobility management and/or session management signaling, whereas user plane traffic may include application data between a UE and an application server. In this example, the network functions include the AMF 508, SMF 510, AF(s) 514, NRF 516, and NEF 518. Note that the CN 500 may include other network functions in addition to or instead of these examples.

The service-based architecture may enable a cloud-based CN. For example, any of the various functions of the CN 500 may be or include a logical function that is hosted at or on a computational device, such as a network entity, computer, server, virtual server, etc. One or more of the functions may be virtualized to allow virtual network entities to operate using a shared computing platform (e.g., a cloud computing platform). For example, a network entity may be configured to host, perform, and/or support any of the various functions of the CN 500. In some aspects, any of the various functions of the CN 500 may correspond to a network entity and/or a shared computing platform that hosts the given function. Note that other architectures for the CN may be used in addition to or instead of the service-based architecture, such as a reference point architecture, a roaming architecture, etc.

As examples, the AMF 508 may perform registration management, connection management, reachability management, mobility management, access authentication, and access authorization of the UE 504. The SMF 510 may perform PDU session management, such as allocating and managing the UE internet protocol (IP) address. The UPF 512 routes and forwards user plane traffic between the RAN 502 and the data network 506.

The AF(s) 514 is a control plane function that interacts with other functions (e.g., the AMF 508, SMF 510, and UPF 512) to provide support for one or more specific services. For example, the AF(s) 514 may include a control plane function for managing a video streaming service, a social media service, and/or a video game service. In some cases, an AF 514 may be co-located at a network entity (such as a base station, CU, DU, and/or RU) to facilitate reduced latency and/or reduce transport bandwidth between the network entity and the service.

The NRF 516 may serve as a repository that allows network functions to register their services and then allows other network functions to discover those services and corresponding network functions. As an example, for network function registration, upon initial activation and/or reconfiguration, a network function (e.g., a specific AF 514) may register the services that are managed at the network function with the NRF 516, and the NRF 516 may store a network function profile for later discovery by other network functions. For network function discovery, a network function may request for information associated with a specific network function from the NRF 516, and the NRF 516 may provide the requested information to the network function.

The NEF 518 may support secure exposure of capabilities and events associated with the CN 500 and/or UE 504 to an external network entity (not shown) and may enable secure provision of information from the external network entity to CN 500. For example, network function capabilities and events may be securely exposed by the NEF 518 to support, for example, third party services (e.g., analytics monitoring of a streaming service), application functions, edge computing, etc.

Note that any of the network entities (e.g., the AMF 508, SMF 510, UPF 512, AF(s) 514, NRF 516, and/or NEF 518) in the CN 500 may perform other functions in addition to or instead of those described for the respective entity.

In certain aspects, the CN 500 may include a data analytics framework having a network data analytics function (NWDAF) 522 and a data collection application function (DCAF) 524. The NWDAF 522 may provide analytics to network functions in the CN 500 and/or a network controller 550. The analytics may include, for example, performance statistics and/or predictions associated with the operations of the CN 500 and/or the RAN 502. As an example, the NWDAF 522 may predict the mobility of the UE, for example, as a prediction of a route a UE will take through a network coverage area and the corresponding network entities that can service communications with the UE on such a route. As another example, the NWDAF 522 may provide network slice monitoring, which may include the monitoring of network performance and quality of service on one or more network slices and/or one or more users/subscribers. The network slice monitoring may allow a communications service provider to meet the terms of a service licensing agreement, for example, which specifies certain levels of QoS for a subscriber or user. In certain aspects, the NWDAF 522 may perform ML model training on ML model(s) deployed at or in the CN 500 and/or the RAN 502 (e.g., ML models used for network analytics).

The network controller 550 may configure and manage the CN 500 and/or the RAN 502. The network controller may enable the operations, administration, and maintenance of the CN 500 and/or the RAN 502. For example, the network controller 550 may collect performance data, events, and/or alarms reported by the CN 500 and/or the RAN 502 and provide visualizations of such data. The network controller 550 may provide a platform for provisioning and/or maintaining the CN 500 and/or the RAN 502. In certain cases, the network controller 550 may be or include the Near-RT RIC 225, the Non-RT RIC 215, and/or the SMO Framework 205, for example, in an Open RAN or cloud-based RAN architecture. In some cases, the network controller 550 may be or include an operations, administration, and maintenance (OAM) host or server.

The NWDAF 522 may interact with the DCAF 524 to collect data from UE application(s) (e.g., a streaming service application, a gaming service application, a social media service application, etc.) running at the UE 504 as an input for analytics generation and/or ML model training at the NWDAF 522. A data collection request from NWDAF 522 may trigger the DCAF 524 to collect data from a UE application. The UE application running at the UE 504 may establish a connection to the DCAF 524 over user (or data) plane via a PDU session, and the DCAF 524 communicates with the UE application and collects data from the UE Application.

Reference to a RAN performing certain operations, as discussed herein, may refer to one or more network entities (e.g., a base station, a non-terrestrial network, and/or one or more disaggregated entities thereof) performing the operations. Reference to a CN performing certain operations, as discussed herein, may refer to one or more physical and/or logical network entities (e.g., a network functions and/or application functions) performing the operations.

### Example Wireless Communications System for Extended Reality Service

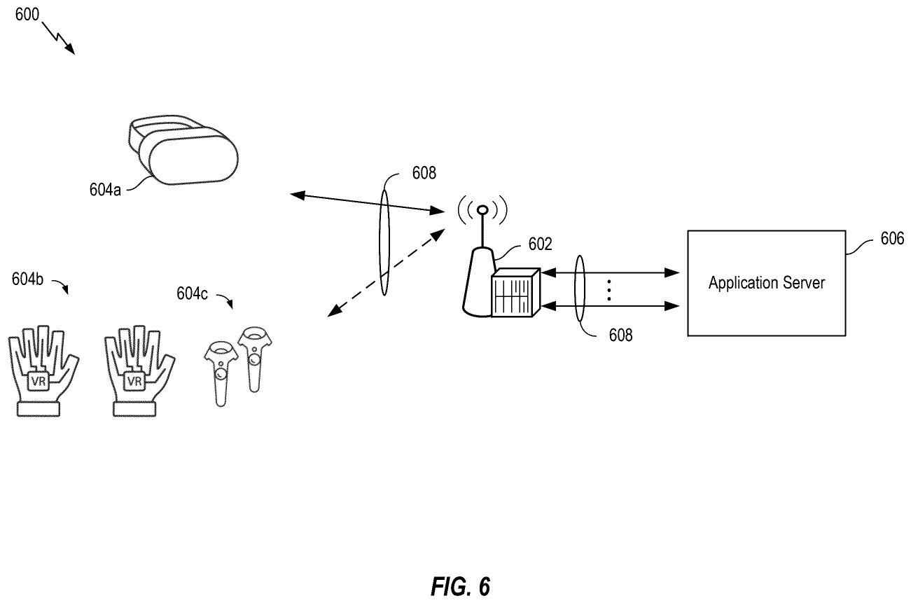

FIG. 6 illustrates an example wireless communications system 600 where one or more XR devices 604a-c are engaged in communications of a multi-modal service, such as XR traffic. As an example, an XR session with XR traffic may impose certain QoS specifications across various traffic streams. An XR device may send a video stream to a server to be processed, for example, with XR content, and the server may send the processed video stream with the XR content to the XR device. Thus, an XR session may have uplink video frame traffic that includes video frames varying in size and/or large in size. Such video traffic may have a high reliability specification (e.g., 99% or more), for example, in terms of a packet error rate (PER). The XR session may also have uplink traffic for pose information, gesture information, control information, sensor measurements, one or more audio channels, etc. As an example, the pose traffic and/or the gesture traffic may have a low latency specification (e.g., less than 10 ms), for example, in terms of a packet delay budget (PDB).

In the example shown in FIG. 6, the XR devices 604a-c may communicate with an application server 606 through a network entity 602. The XR devices 604a-c may be an example of one or more UEs that communicate the multi-modal traffic of one or more users. In some cases, the XR devices 604a-c may communicate multi-modal traffic of a single user. For example, the XR devices 604a-c may be or include XR glasses, an XR headset (604a), XR gloves (604b), XR controllers (604c), one or more sensors, an XR base station, etc. The network entity 602 may be an example of the BS 102 or any disaggregated entity thereof as described herein with respect to FIG. 2. The application server 606 may be or include an XR application server that hosts certain XR content for the XR devices 604a-c. The application server 606 may be or include one or more computing devices including, for example, a server, a computer (e.g., a laptop computer, a tablet computer, a personal computer (PC), a desktop computer, etc.), a virtual device, or any other electronic device or computing system capable of hosting one or more XR sessions or multi-modal services.

The XR devices 604a-c may communicate multi-modal traffic 608 via one or more wireless communication channels between the XR devices 604a-c and the network entity 602. The network entity 602 may route the multi-modal traffic 608 between the application server 606 and the XR devices 604a-c. The multi-modal traffic 608 may include various traffic streams associated with a service (e.g., an XR session) including, for example, pose traffic, control traffic, sensor traffic, haptic traffic, video traffic, and/or audio traffic. As an example of some traffic involved in cloud-based AR rendering, the application server 606 may obtain video frames captured at an XR headset (604a) along with pose information and/or control information. The application server 606 may overlay (or determine where to overlay) computer generated content in the video frames, such as textual information or computer generated visualizations. The application server 606 may send, to the XR headset (604a), the augmented video frames and/or information to render the augmented video frames at the XR headset (604a). In some cases, the application server 606 may send other traffic streams to the XR devices 604a-c, such as audio traffic, haptic feedback information, etc.

### Example Protocol Stacks

Certain wireless communications systems (e.g., 5G NR systems or any future wireless communications system) may employ protocol stack(s) to transfer information between a UE and a network node, such as a base station and/or core network. As an example, 5G NR systems may use a user plane protocol stack and a control plane protocol stack to exchange application data and signaling messages. A user plane protocol stack may be responsible for transferring application data between the UE and an application server, and a control plane protocol stack may be responsible for transferring control signaling messages between the UE and a network node.

FIG. 7A depicts an example control plane protocol stack 700a for exchanging control plane traffic (e.g., control signaling) between a UE 704 and a network node 702, and between the UE 704 and a core network 790. In some aspects, the network node 702 may be an example of the BS 102 and/or network entities 300/302 depicted and described with respect to, respectively, FIG. 1 or 3 or a disaggregated base station depicted and described with respect to FIG. 2. Similarly, the UE 704 may be an example of UE 104 or UE 304 depicted and described with respect to, respectively, FIG. 1 or 3. The core network 790 may be an example of the 5GC network 190 and/or the core network 220 depicted and described with respect to FIG. 1 or 2, respectively.

The control plane protocol stack 700a includes a non-access stratum (NAS) layer 710, a radio resource control (RRC) layer 712, a packet data convergence protocol (PDCP) layer 714, a radio link control (RLC) layer 716, a medium access control (MAC) layer 718, and a physical (PHY) layer 720. The NAS layer 710 carries mobility management and session management signaling between the UE 704 and the core network 790 (e.g., the AMF 192 and/or the SMF 194 of FIG. 1). The RRC layer 712 carries RRC signaling, for example, for paging, RRC connection establishment, RRC connection reconfiguration, and RRC connection release. The PDCP layer 714 provides ciphering and integrity protection for control plane signaling. The RLC layer 716 may segment a large packet into smaller packets and handles re-transmissions of RLC packets. The MAC layer 718 schedules transmissions between the UE 704 and the network node 702 and controls the PHY layer 720. In the MAC layer 718, the UE 704 and the network node 702 may communicate with each other by exchanging a MAC control element (MAC CE). The PHY layer 720 handles transmission and reception across the air-interface between the UE 704 and the network node 702. The PHY layer 720 provides certain error management tasks (e.g., cyclic redundancy check), certain digital signaling processing tasks (e.g., modulation and demodulation), and handles certain procedures for measurement and control (e.g., beam failure detection and/or radio link monitoring). The network node 702 may send, to the UE 704, PHY layer signaling via downlink control information (DCI).

FIG. 7B depicts an example user plane protocol stack 700b for exchanging user plane traffic (e.g., application data) between the UE 704 and the network node 702. The user plane protocol stack 700b includes a service data adaptation protocol (SDAP) layer 722, the PDCP layer 714, the RLC layer 716, the MAC layer 718, and the PHY layer 720. The SDAP layer 722 maps the QoS flow(s) used at the core network 790 (e.g., for a protocol data unit (PDU) session) to data radio bearer(s) used at the network node 702 to communicate via an air-interface between the UE 704 and the network node 702. In the user plane, the PDCP layer 714 provides packet header compression (e.g., transmission control protocol (TCP), user datagram protocol (UDP), and/or internet protocol (IP) header compression), ciphering, and integrity protection for user plane traffic.

The RRC layer 712 may form Layer-3 (L3) of the control plane protocol stack 700a. In the user plane, the SDAP layer 722, the PDCP layer 714, the RLC layer 716, and/or the MAC layer 718 may form Layer-2 (L2) of the user plane protocol stack 700b. In the control plane, the PDCP layer 714, the RLC layer 716, and/or the MAC layer 718 may form L2 of the control plane protocol stack 700a. The PHY layer 720 may form Layer-1 (L1) of the protocol stacks (e.g., the control plane protocol stack 700a and the user plane protocol stack 700b). Layer-3 may include the highest or upper layers in the control plane protocol stack 700a; Layer-2 may include the intermediate layers in the control plane protocol stack 700a, where Layer-2 is arranged between Layer-3 and Layer-1; and Layer-1 may include the lowest layer in the control plane protocol stack 700a.

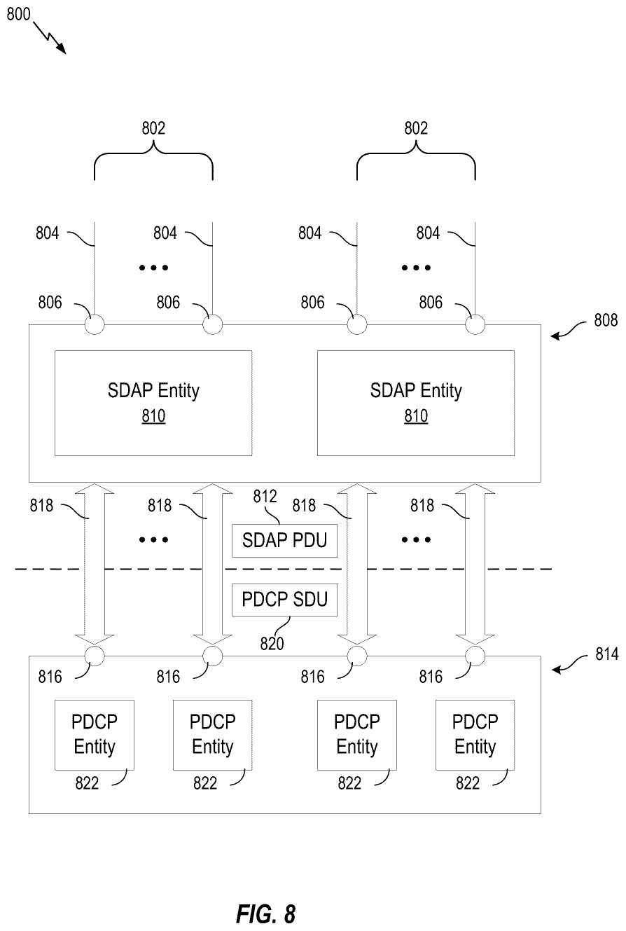

FIG. 8 depicts an example 800 for structure of an SDAP sublayer. The SDAP sublayer (e.g., the functional entity that operates at the SDAP layer, such as SDAP layer 722 of FIG. 7B) supports the following functions: transfer of user plane data, mapping between a QoS flow and a data radio bearer (DRB) for both DL and UL, marking QFI in both DL and UL packets, and RQoS flow to DRB mapping for the UL SDAP data PDUs. A DRB is a bearer that carries data packets between a UE and the network. In the depicted example 800, each of PDU sessions 802 has a plurality of QoS flows 804. The QoS flows 804 are processed at SDAP service access points (SAPs) 806 of SDAP sublayer 808. An SDAP SAP 806 may be a network endpoint or location where SDAP layer services may be accessed. The SDAP sublayer 808 may include a plurality of SDAP entities 810, which provide the SDAP services (e.g., the functions as provided above and as described herein with reference to SDAP layer 722 of FIG. 7B) and handle SDAP PDUs 812.

An SDAP PDU 812 becomes a payload for PDCP sublayer 814, which provides PDCP services at PDCP SAPs 816 via radio bearers 818. For example, the SDAP PDU 812 becomes a payload of PDCP service data unit (SDU) 820, which is processed by PDCP entities 822. PDCP entities 822 provide the PDCP services (e.g., as described herein, for the user plane, with reference to PDCP layer 714 of FIG. 7B). At the transmitting side, when an SDAP entity 810 receives an SDAP SDU from upper layers, the SDAP entity 810 constructs the corresponding SDAP data PDU (SDAP PDU 812) and submits it to lower layers (e.g., as a PDCP SDU 820). At the receiving side, when an SDAP entity 810 receives an SDAP data PDU (SDAP PDU 812) from lower layers, it retrieves the corresponding SDAP SDU and delivers it to upper layers.

FIG. 9 depicts an example 900 of mapping of application flows to logical channel groups for PDU sessions. As depicted, PDU sessions 902 (e.g., including a first PDU session 902a, a second PDU session 902b, a third PDU session 902c, and a fourth PDU session 902d) have several application flows 904 (including application flows 904a-h). The PDU sessions 902 may correspond to connections for various examples of applications or services, such as relating to MBB, video streaming, XR or gaming, machine type communication (MTC), etc., which may be configured for different sets of QoS characteristics or specifications. In the depicted example 900, the application flows 904a-h are grouped to, respectively, QoS flows 906a-e (collectively referred to as QoS flow(s) 906) based on QoS characteristics or specifications, such as relating to bit rate, latency, and/or the like. As depicted, data of the QoS flows 906 may be provided as SDAP PDUs 908 (including a first SDAP PDU 908a corresponding to the first PDU session 902a, a second SDAP PDU 908b corresponding to the second PDU session 902b, a third SDAP PDU 908c corresponding to the third PDU session 902c, and a fourth SDAP PDU 908d corresponding to the fourth PDU session 902d). The SDAP PDUs 908 may be carried via data radio bearers (DRBs) 910 (e.g., via a first DRB 910a, a second DRB 910b, a third DRB 910c, and a fourth DRB 910d, respectively), which may be grouped or mapped into LCGs 912 (including a first LCG 912a, a second LCG 912b, and a third LCG 912c, respectively). Then, subject to certain LCP rules at 914 (e.g., a priority level or score), the first DRB 910a, the second DRB 910b, the third DRB 910c, and the fourth DRB 910d may be encoded as a MAC transport block (TB) 916. For example, the first DRB 910a and the second DRB 910b, grouped as the first LCG 912a, may be encoded as the first portion of TB 916a. The third DRB 910c, grouped as the second LCG 912b, may be encoded as the second portion of TB 916b, and the fourth DRB 910d, grouped as the third LCG 912c, may be encoded as the third portion of TB 916c.

In the depicted example 900, the encoded MAC TB 916, which also includes a MAC CE 916d and a padding 916e, includes the highest amount of data for the first LCG 912a, the next highest amount of data for the second LCG 912b, and the lowest amount of data for the third LCG 912c. For example, these amounts of data may be based on the first LCG 912a being configured the highest priority level, the second LCG 912b being configured the next highest priority level, and the third LCG 912c being configured the lowest priority level. Such prioritization may be based on the applications (e.g., the types of applications) associated with the PDU sessions 902, where for example, the QoS flows 906a-c may be for applications subject to higher bit rates and/or lower latencies than, for example, the applications associated with QoS flows 906d-h.

### Aspects Related to Indicating a Quality of Service Flow Level Congestion by Service Data Adaptation Protocol Sublayer

In certain aspects, when a specific QoS flow is not satisfying the QoS criteria defined based on scheduling pattern (e.g., indicating a QoS flow level congestion), a QoS flow level congestion (e.g., congestion of a QoS flow, such as a QoS flow 906 described with respect to FIG. 9) may occur. The PDCP, RLC, and/or MAC entities can indicate this QoS flow level congestion to SDAP entity (e.g., SDAP entity 810 described with respect to FIG. 8), where the QoS flow level congestion may be based on, for example, a packet drop rate for the QoS flow, etc. The SDAP entity may indicate the QoS flow level congestion (e.g., for a particular QFI) using SDAP based signaling. For example, an SDAP control PDU may be configured to carry the indication of the QoS flow level congestion to a peer entity, such as from UE to the network in uplink case (or vice versa). While certain aspects of the present disclosure are described in the context of an uplink case, aspects of the present disclosure may apply to a downlink case, too, without departing from the spirit or the scope of the present disclosure. For example, the techniques described herein can apply either in uplink case (e.g., from UE to the network) or in downlink case (e.g., from the network to UE), depending on radio conditions and scheduling behavior. The techniques described herein may control a codec rate in each direction. For example, there may be cases where downlink scheduling is not an issue but uplink scheduling is an issue due to power headroom report (PHR), or where downlink scheduling is an issue due to interference, scheduling pattern, buffer loading, etc.

In some aspects, the network can take one or more actions to resolve the QoS flow level congestion indicated via the SDAP control PDU. For example, the network may increase the size of a grant without a modification in a mapping between a QoS flow and a radio bearer. In other examples, the network may modify the mapping between a QoS flow and a radio bearer in accordance with a static QoS mechanism or a dynamic QoS mechanism, modify the logical channel configuration for a grant, and/or modifying one or more logical channel parameters.

Example Signaling of Indicating a Quality of Service Flow Level Congestion by Service Data Adaptation Protocol Sublayer

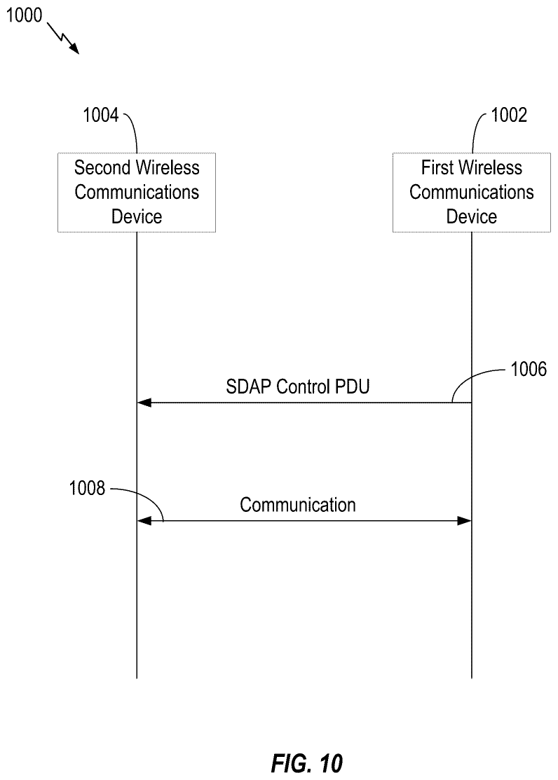

FIG. 10 depicts a process flow 1000 for communications in a network between a first wireless communications device 1002 and a second wireless communications device 1004. In some aspects, the first wireless communications device 1002 may be an example of the BS 102 depicted and described with respect to FIG. 1, the first network entity 300 or the second network entity 302 depicted and described with respect to FIG. 3, the RAN 502 depicted and described with respect to FIG. 5, the network entity 602 depicted and described with respect to FIG. 6, the network node 702 depicted and described with respect to FIG. 7A or 7B, or a disaggregated base station depicted and described with respect to FIG. 2. Similarly, the second wireless communications device 1004 may be an example of UE 104 depicted and described with respect to FIG. 1, the UE 304 depicted and described with respect to FIG. 3, the UE 504 depicted and described with respect to FIG. 5, the XR devices 604a-c depicted and described with respect to FIG. 6, or the UE 704 depicted and described with respect to FIG. 7A or 7B.

In certain aspects, the second wireless communications device 1004 may be an example of the BS 102 depicted and described with respect to FIG. 1, the first network entity 300 or the second network entity 302 depicted and described with respect to FIG. 3, the RAN 502 depicted and described with respect to FIG. 5, the network entity 602 depicted and described with respect to FIG. 6, the network node 702 depicted and described with respect to FIG. 7A or 7B, or a disaggregated base station depicted and described with respect to FIG. 2. Similarly, the first wireless communications device 1002 may be an example of UE 104 depicted and described with respect to FIG. 1, the UE 304 depicted and described with respect to FIG. 3, the UE 504 depicted and described with respect to FIG. 5, the XR devices 604a-c depicted and described with respect to FIG. 6, or the UE 704 depicted and described with respect to FIG. 7A or 7B. However, in other aspects, the first wireless communications device 1002 and/or the second wireless communications device 1004 may each be another type of wireless communications device, such as those described herein. Note that any operations or signaling illustrated with dashed lines may indicate that that operation or signaling is an optional or alternative example.

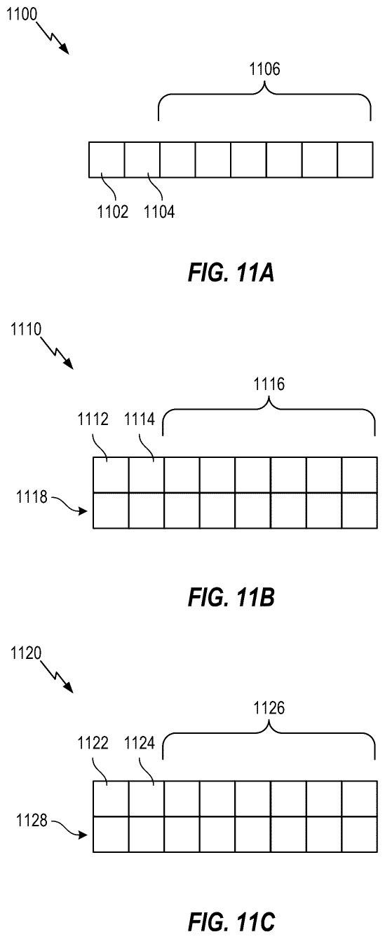

At 1006, the first wireless communications device 1002 sends an SDAP control PDU comprising an indication of a QoS flow level congestion, such as described above. In certain aspects, the SDAP control PDU may be an example of the SDAP PDU 812 described with respect to FIG. 8 or the SDAP control PDU described with respect to FIGS. 11A, 11B, or 11C.

At 1008, the first wireless communications device 1002 communicates with the second wireless communications device 1004 in accordance with the indication of the QoS flow level congestion.

In certain aspects, communicating with the second wireless communications device 1004 in accordance with the indication of the QoS flow level congestion may include performing a communication in accordance with an increased size of a grant without a modification in a mapping between a QoS flow of the communication and a radio bearer. For example, the network (e.g., the second wireless communications device 1004) may change (e.g., increase) the size of a grant without a modification in a mapping between a QoS flow of the communication and a radio bearer (e.g., DRB). The first wireless communications device 1002 may obtain or receive this change to the size of the grant. The first wireless communications device 1002 may communicate with the second wireless communications device 1004 using a grant of the changed size.

In certain aspects, communicating with the second wireless communications device 1004 in accordance with the indication of the QoS flow level congestion may include performing a communication in accordance with a modified mapping between a QoS flow of the communication and a radio bearer, the modified mapping being in accordance with a static QoS mechanism or a dynamic QoS mechanism. For example, the network (e.g., the second wireless communications device 1004) may modify the mapping between a QoS flow of the communication and a radio bearer in accordance with a static QoS mechanism or a dynamic QoS mechanism. In some cases, the first wireless communications device 1002 may obtain or receive an indication of the modified mapping, such as from the second wireless communications device 1004. In some aspects, the static QoS mechanism may include a RRC signaling mechanism, such as an RRC reconfiguration of the mapping. In some aspects, the dynamic QoS mechanism may include an RQoS mechanism. The RQoS mechanism involves the network (e.g., the second wireless communications device 1004) measuring and monitoring QoS parameters, such as latency, packet loss, and jitter, and making adjustments based on the feedback received from a UE or an application server. Such adjustment may be made by a network controller in real-time, and may include adjusting network settings, such as resource allocation, routing, and/or scheduling policies.

In certain aspects, communicating with the second wireless communications device 1004 in accordance with the indication of the QoS flow level congestion may include performing a communication in accordance with a modified logical channel configuration for a grant, where the grant may be based on one or more logical channel parameters. For example, the network (e.g., the second wireless communications device 1004) may modify the logical channel configuration. In some cases, the first wireless communications device 1002 may obtain or receive the modification of the logical channel configuration. The modification to the logical channel configuration may include modification of one or more logical channel parameters, such as a PBR, a BSD, a priority, or the like.

In certain aspects, communicating with the second wireless communications device 1004 in accordance with the indication of the QoS flow level congestion may include performing a communication in accordance with one or more modified configuration parameters at one or more of: a PDCP layer, a RLC layer, a MAC layer, or a PHY layer. For example, the network (e.g., the second wireless communications device 1004) may modify certain configuration parameters at one or more of the PDCP layer, the RLC layer, the MAC layer, or the PHY layer, such as to perform logical channel configuration update, radio bearer configuration update, cell mapping update, configured grant update, etc.

In certain aspects, the first wireless communications device 1002 may include a UE, and the second wireless communications device 1004 may include a network entity. In some aspects, the first wireless communications device 1002 may include a network entity, and the second wireless communications device 1004 may include a user equipment.

In certain aspects, the indication of the QoS flow level congestion may include a congestion indication for a QFI, where the congestion indication may be within a defined field of the SDAP control PDU. The congestion indication within the defined field of the SDAP control PDU is described further herein with reference to FIG. 11A.

In certain aspects, the indication of the QoS flow level congestion may include an explicit indication of a QoS flow rate adaptation value for a QFI. The explicit indication of a QoS flow rate adaptation value for a QFI is described further herein with reference FIG. 11B.

In certain aspects, the indication of the QoS flow level congestion may include an index value corresponding to a QoS flow rate adaptation value for a QFI. The index value corresponding to a QoS flow rate adaptation value for a QFI is described further herein with reference to FIG. 11C.

In certain aspects, communicating with the second wireless communications device 1004 in accordance with the indication of the QoS flow level congestion may include performing a communication with one or more data packets dropped for a QoS flow associated with the QoS flow level congestion. The one or more data packets may be dropped based on a significance indication. The significance indication may include a relative level of significance of the one or more data packets compared to other data packets for the QoS flow or for multiple QoS flows. The relative level of significance of the one or more data packets may be based on application level information. For example, based on the indication of a QoS flow level congestion, the network (e.g., the second wireless communications device 1004) may drop a specific set of one or more data packets based on their significance within the QoS flow associated with the QoS flow level congestion or across multiple flows. In some cases, the specific set of one or more data packets may be dropped based on application level information. For example, application level information may be based on one or more QoS parameters defined for a given flow and across multiple flows, such as the amount of redundancy and other QoS characteristics defined for a given application frame.

In certain aspects, a wireless communications device (e.g., a peer radio entity) may communicate with an application to change a codec rate based on the indication of a QoS flow level congestion described herein. For example, a codec rate may be changed such that a video stream may be changed from a 4K video stream to a 1080p video stream and then to a 720p video stream. In some cases, a codec format may be changed based on the indication of a QoS flow level congestion. For example, a codec format may be changed from a moving picture experts group (MPEG) format such as an MP4 format to a Flash format such as a Flash video (FLV) format. Such change of a codec rate or format may be based on an application level coordination. Additionally, the network (e.g., the second wireless communications device 1004) may change (e.g., increase or decrease) one or more logical channel parameters to ensure that a given logical channel that may be experiencing a congestion will have additional opportunities to send data on a bearer (e.g., when compared to other bearers for a given grant). Such change of one or more logical channel parameters may be based on a radio level coordination. These changes (e.g., of a codec rate or of logical channel parameters) may be enabled based on the indication of a QoS flow level congestion described herein.

Note that the process flow illustrated in FIG. 10 is an example of indicating a QoS flow level congestion level at the SDAP sublayer and communicating in accordance with the indication of the QoS flow level congestion, and aspects of the present disclosure may be applied to indicating a QoS flow level congestion level at the SDAP sublayer and communicating in accordance with the indication of the QoS flow level congestion. Note that the process flow illustrated in FIG. 10 is described herein to facilitate an understanding of indicating a QoS flow level congestion level at the SDAP sublayer and communicating in accordance with the indication of the QoS flow level congestion, and aspects of the present disclosure may be performed in various manners via alternative or additional signaling and/or operations. In certain aspects, the operations and/or signaling of FIG. 10 may occur in an order different from that described or depicted, and various actions, operations, and/or signaling may be added, omitted, or combined.

FIGS. 11A, 11B, and 11C depict various example aspects of data structures for an SDAP control PDU, such as the SDAP control PDU transmitted at 1006. For example, an SDAP control PDU may be configured to indicate the QoS flow level congestion along with different levels of information to a peer entity.

FIG. 11A depicts an example SDAP control PDU 1100. The example SDAP control PDU 1100 includes a D/C field 1102, a reserved field 1104, and a QFI field 1106. The D/C field 1102 is used to indicate whether the PDU is a control PDU or a data PDU. As an example, a value of 0 in the D/C field 1102 indicates a control PDU, and a value of 1 in the D/C field 1102 indicates a data PDU. The example SDAP control PDU 1100 as a control PDU (e.g., when the D/C field 1102 is set to a value of 0) may serve as an end-marker control PDU used by SDAP entity at UE to indicate that it stops the mapping of an SDAP SDU of a QoS flow indicated by a QFI to the DRB on which the end-marker PDU is transmitted. The example SDAP control PDU 1100 as a data PDU (e.g., when the D/C field 1102 is set to a value of 1) may be used to convey one or more of followings: an SDAP header or user plane data. Accordingly, the D/C field 1102 may be set to a value of 0 to indicate that the example SDAP control PDU 1100 is a control PDU for the aspects described herein. The QFI field 1106 may include the QFI information.

In certain aspects, the reserved field 1104 may be used for the indication of a QoS flow level congestion, such as for a QFI indicated in the QFI field 1106. For example, a value of 0 in the reserved field 1104 may not indicate a QoS flow level congestion or may indicate no QoS flow level congestion. In some cases, a value of 0 in the reserved field 1104 may be used to indicate that the example SDAP control PDU 1100 is an end marker on the QFI indicated in the QFI field 1106. A value of 1 in the reserved field 1104 may indicate a QoS flow level congestion on the QFI indicated in the QFI field 1106, such that the example SDAP control PDU 1100 serves as a QoS flow level congestion indicator and not an end marker. Accordingly, the network (e.g., the second wireless communications device 1004 of FIG. 10) may take certain one(s) of the actions described herein with reference to FIG. 10, which would be in accordance with an accurate indication of a congestion for a specific QFI, thus accurately addressing the QFI-specific congestion.

FIG. 11B depicts an example SDAP control PDU 1110. The example SDAP control PDU 1110 includes a D/C field 1112, a reserved field 1114, a QFI field 1116, and a QoS flow rate adaptation value field 1118. The D/C field 1112 is used to indicate whether the PDU is a control PDU or a data PDU. As an example, a value of 0 in the D/C field 1112 indicates a control PDU, and a value of 1 in the D/C field 1112 indicates a data PDU. The example SDAP control PDU 1110 as a control PDU (e.g., when the D/C field 1112 is set to a value of 0) may serve as an end-marker control PDU used by SDAP entity at UE to indicate that it stops the mapping of an SDAP SDU of a QoS flow indicated by a QFI to the DRB on which the end-marker PDU is transmitted. The example SDAP control PDU 1110 as a data PDU (e.g., when the D/C field 1112 is set to a value of 1) may be used to convey one or more of following: an SDAP header or user plane data. Accordingly, the D/C field 1112 may be set to a value of 0 to indicate that the example SDAP control PDU 1110 is a control PDU for the aspects described herein. The QFI field 1116 may include the QFI information.

In certain aspects, the reserved field 1114 may be used for the indication of a QoS flow level congestion, such as for a QFI indicated in the QFI field 1116. For example, a value of 0 in the reserved field 1114 may not indicate a QoS flow level congestion or may indicate no QoS flow level congestion. In some cases, a value of 0 in the reserved field 1114 may be used to indicate that the example SDAP control PDU 1110 is an end marker on the QFI indicated in the QFI field 1116. A value of 1 in the reserved field 1114 may indicate a QoS flow level congestion on the QFI indicated in the QFI field 1116, such that the example SDAP control PDU 1110 serves as a QoS flow level congestion indicator and not an end marker.

Additionally, the QoS flow rate adaptation value field 1118 may be used to add additional information as part of the example SDAP control PDU 1110. For example, the QoS flow rate adaptation value field 1118 may indicate a specific value (e.g., a specific codec rate) explicitly, where the value may be based on the dynamic radio conditions, user experience, and/or SLA. This value can be derived based on the application, radio conditions, and relative importance in the multi-modal flows relation and coexistence. Thus, the indication of the QoS flow level congestion (such as in the example SDAP control PDU 1110) may include an explicit indication of a specific QoS flow rate adaptation value for a QFI (such as in the QoS flow rate adaptation value field 1118).

Accordingly, the network (e.g., the second wireless communications device 1004 of FIG. 10) may take certain one(s) of the actions described herein with reference to FIG. 10, which would be in accordance with an accurate indication of a congestion for a specific QFI, thus accurately addressing the QFI-specific congestion. Moreover, the network can cause a codec rate to be adjusted based on an absolute value of the codec for the specific QFI based on the application, radio, as well as multi-modal relation for a given scheduling pattern (e.g., based on the QoS flow rate adaptation value field 1118). An absolute value may indicate an exact codec rate (e.g., 425 kbit/sec), as opposed to an index value which may be mapped to a predefined and corresponding codec rate. While only 8 bits are shown for the QoS flow rate adaptation value field 1118 in FIG. 11B, less or additional bits may be used to indicate the absolute value of the codec rate.

In certain aspects, the explicit indication of a specific QoS flow rate adaptation value (e.g., a specific codec rate) may provide the technical benefit of specifying the codec rate to be used (e.g., available at the application level) when there is no clear indication of a standard codec rate between the first wireless communications device and the second wireless communications device. Accordingly, aspects of the present disclosure including the explicit indication of a specific QoS flow rate adaptation value may provide granularity and flexibility in specifying the specific codec rate to be used for a specific QoS flow (associated with a specific QFI). Using a specific codec rate for a specific QoS flow may accurately address a QoS flow level congestion, resulting in improved bit rate and/or reduced latency.

FIG. 11C depicts an example SDAP control PDU 1120. The example SDAP control PDU 1120 includes a D/C field 1122, a reserved field 1124, a QFI field 1126, and a QoS flow rate adaptation value index field 1128. The D/C field 1122 is used to indicate whether the PDU is a control PDU or a data PDU. As an example, a value of 0 in the D/C field 1122 indicates a control PDU, and a value of 1 in the D/C field 1122 indicates a data PDU. The example SDAP control PDU 1120 as a control PDU (e.g., when the D/C field 1122 is set to a value of 0) may serve as an end-marker control PDU used by SDAP entity at UE to indicate that it stops the mapping of an SDAP SDU of a QoS flow indicated by a QFI to the DRB on which the end-marker PDU is transmitted. The example SDAP control PDU 1120 as a data PDU (e.g., when the D/C field 1122 is set to a value of 1) may be used to convey one or more of followings: an SDAP header or user plane data. Accordingly, the D/C field 1122 may be set to a value of 0 to indicate that the example SDAP control PDU 1120 is a control PDU for the aspects described herein. The QFI field 1126 may include the QFI information.

In certain aspects, the reserved field 1124 may be used for the indication of a QoS flow level congestion, such as for a QFI indicated in the QFI field 1126. For example, a value of 0 in the reserved field 1124 may not indicate a QoS flow level congestion or may indicate no QoS flow level congestion. In some cases, a value of 0 in the reserved field 1124 may be used to indicate that the example SDAP control PDU 1120 is an end marker on the QFI indicated in the QFI field 1126. A value of 1 in the reserved field 1124 may indicate a QoS flow level congestion on the QFI indicated in the QFI field 1126, such that the example SDAP control PDU 1120 serves as a QoS flow level congestion indicator and not an end marker.

Additionally, the QoS flow rate adaptation value index field 1128 may be used to indicate what QoS flow rate may be used for the codec. For example, each QoS flow may be configured with a plurality of codec rates during QoS configuration. In certain aspects, the example SDAP control PDU 1120 may indicate an index corresponding to a configured codec rate from the list of configured codec rates to indicate which one of the configured codec rates is be adapted. Thus, the indication of the QoS flow level congestion may include an index value corresponding to a specific QoS flow rate adaptation value for a QFI.

Accordingly, the network (e.g., the second wireless communications device 1004 of FIG. 10) may take certain one(s) of the actions described herein with reference to FIG. 10, which would be in accordance with an accurate indication of a congestion for a specific QFI, thus accurately addressing the QFI-specific congestion. Moreover, the explicitly indexed value for the codec rate may be QFI-specific and based on the application, radio, as well as multi-modal relation for a given scheduling pattern.

In certain aspects, the index value corresponding to a specific QoS flow rate adaptation value (e.g., one of a list of configured QoS flow rate adaptation values) may provide the technical benefit of specifying the codec rate to be used by using a reduced amount of information included in the SDAP control PDU (e.g., when compared to adding an explicit indication of a specific QoS flow rate adaptation value). For example, a codec rate may be identified for the communication between the first wireless communications device and the second wireless communications device without using as many bits to indicate the actual codec rate to be used. For example, a specific codec rate may be identified based on an index value such as 0, 1, 2, 3, etc. (using only two bits), rather than a large value such as 425,000 (indicating 425 kbit/sec). Accordingly, aspects of the present disclosure including the index value corresponding to a specific QoS flow rate adaptation value may provide the flexibility in specifying the specific codec rate (of a list of configured codec rates) to be used for a specific QoS flow (associated with a specific QFI) without significantly increasing the size of the SDAP control PDU to explicitly indicate a large number. Using a specific codec rate for a specific QoS flow may accurately address a QoS flow level congestion, resulting in improved bit rate and/or reduced latency.

In certain aspects, in case of a UE-initiated QoS, the SDAP control PDU described herein may be a request from the UE to maintain a better quality of communication. In case of a network-initiated QoS, the SDAP control PDU described herein may be a command from the network to maintain a quality of communication. In each case, the negotiation of the QoS flow level congestion and QoS flow rate adaptation may be part of a negotiated UE and network capability or support, for example, for better adaptation of the services to dynamically changing loading and radio conditions (e.g., to enable immersive and engaging user experience for a service that needs very stable throughput and low latency, such as for XR or gaming applications).

### Example Operations of a Wireless Communications Device

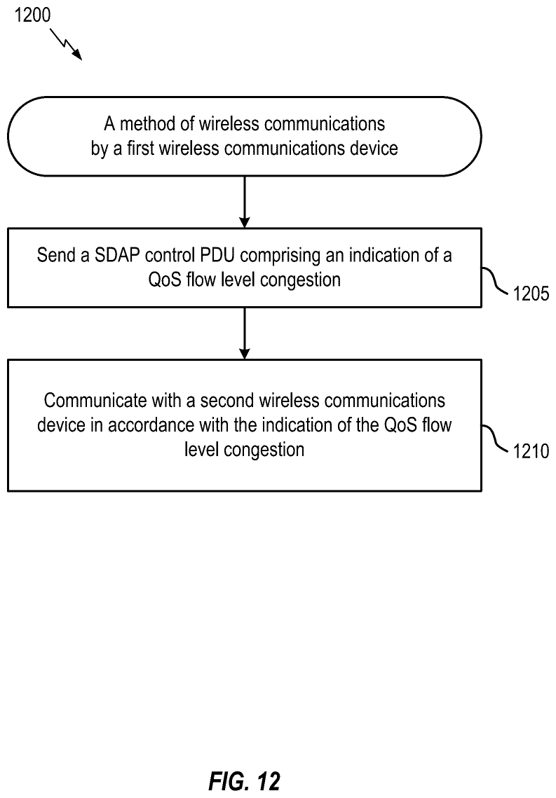

FIG. 12 shows a method 1200 for wireless communications by a first wireless communications device, such as first wireless communications device 1002 of FIG. 10, UE 104 of FIG. 1, UE 304 of FIG. 3, UE 504 of FIG. 5, XR devices 604a-c of FIG. 6, UE 704 of FIG. 7A or 7B, BS 102 of FIG. 1, first network entity 300 or second network entity 302 of FIG. 3, RAN 502 of FIG. 5, network entity 602 of FIG. 6, network node 702 of FIG. 7A or 7B, and/or a disaggregated base station as discussed with respect to FIG. 2.

Method 1200 begins at block 1205 with sending a SDAP control PDU comprising an indication of a QoS flow level congestion. For example, the SDAP control PDU sent may be the SDAP control PDU 1100, 1110, or 1120 described herein with reference to, respectively, FIGS. 11A, 11B, or 11C.

Method 1200 then proceeds to block 1210 with communicating with a second wireless communications device in accordance with the indication of the QoS flow level congestion. For example, the communication in accordance with the indication of the QoS flow level congestion may include the actions that are described herein with reference to FIG. 10, as well as adjusting a codec rate as described herein with reference to, for example, FIGS. 11B and 11C.

In some aspects, block 1210 includes performing a communication in accordance with an increased size of a grant without a modification in a mapping between a QoS flow of the communication and a radio bearer. For example, the second wireless communications device (e.g., second wireless communications device 1004 of FIG. 10) may increase the size of the grant, and the first wireless communications device (e.g., first wireless communications device 1002 of FIG. 10) may obtain or receive the increase in size of the grant. The first wireless communications device may communicate with the second wireless communications device using the increased grant.

In some aspects, block 1210 includes performing a communication in accordance with a modified mapping between a QoS flow of the communication and a radio bearer, the modified mapping being in accordance with a static QoS mechanism or a dynamic QoS mechanism.

In some aspects, the static QoS mechanism comprises a RRC signaling mechanism.

In some aspects, the dynamic QoS mechanism comprises a reflective QoS mechanism.

In some aspects, block 1210 includes performing a communication in accordance with a modified logical channel configuration for a grant, the grant being based on one or more logical channel parameters.

In some aspects, block 1210 includes performing a communication in accordance with one or more modified logical channel parameters at one or more of: a PDCP layer, a RLC layer, a MAC layer, or a PHY layer.

In some aspects, the first wireless communications device comprises a user equipment, and the second wireless communications device comprises a network entity.

In some aspects, the first wireless communications device comprises a network entity, and the second wireless communications device comprises a user equipment.

In some aspects, the indication of the QoS flow level congestion comprises a congestion indication for a QFI, wherein the congestion indication is within a defined field of the SDAP control PDU.

In some aspects, the indication of the QoS flow level congestion comprises an explicit indication of a QoS flow rate adaptation value for a QFI.

In some aspects, the indication of the QoS flow level congestion comprises an index value corresponding to a QoS flow rate adaptation value for a QFI.

In some aspects, block 1210 includes performing a communication with one or more data packets dropped for a QoS flow associated with the QoS flow level congestion, the one or more data packets dropped based on a significance indication comprising a relative level of significance of the one or more data packets compared to other data packets for the QoS flow or for multiple QoS flows, the relative level of significance of the one or more data packets based on application level information.

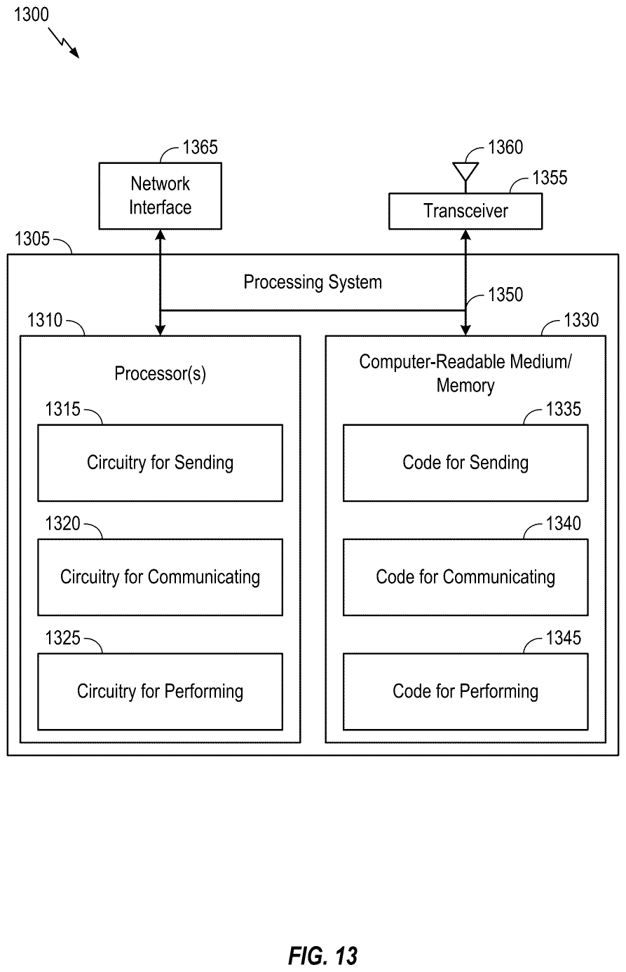

In some aspects, method 1200, or any aspect related to it, may be performed by an apparatus, such as communications device 1300 of FIG. 13, which includes various components operable, configured, or adapted to perform the method 1200. Communications device 1300 is described below in further detail.

In certain aspects, the QoS flow level congestion as indicated through SDAP layer based on method 1200 can help a radio access network to adjust the flow mapping, dynamic grant modification, and/or LC configuration update to improve the overall QoS flow KPIs and to enhance the user experience for the immersive applications like XR based on the improved QoS flow KPIs.

Note that FIG. 12 is just one example of a method, and other methods including fewer, additional, or alternative operations are possible consistent with this disclosure.

### Example Communications Device

FIG. 13 depicts aspects of an example communications device 1300 (such as first wireless communications device 1002 of FIG. 10) configured for wireless communications. In some aspects, communications device 1300 is a user equipment, such as UE 104 described with respect to FIG. 1, UE 304 described with respect to FIG. 3, UE 504 described with respect to FIG. 5, XR devices 604a-c described with respect to FIG. 6, UE 704 described with respect to FIG. 7A or 7B. In some aspects, communications device 1300 is a network entity, such as BS 102 of FIG. 1, first network entity 300 or second network entity of FIG. 3, RAN 502 of FIG. 5, network entity 602 of FIG. 6, network node 702 of FIG. 7A or 7B, or a disaggregated base station as discussed with respect to FIG. 2.

The communications device 1300 includes a processing system 1305 coupled to a transceiver 1355 (e.g., a transmitter and/or a receiver) and/or a network interface 1365. The transceiver 1355 is configured to transmit and receive signals for the communications device 1300 via an antenna 1360, such as the various signals as described herein. The network interface 1365 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310 and a computer-readable medium/memory 1330. In various aspects, the one or more processors 1310 may be representative of the one or more processors 318 described with respect to FIG. 3. The one or more processors 1310 are coupled to a computer-readable medium/memory 1330 via a bus 1350. In some aspects, the computer-readable medium/memory 1330 may be representative of the one or more memories 320 described with respect to FIG. 3. The computer-readable medium/memory 1330 is a non-transitory computer-readable medium/memory. In certain aspects, the computer-readable medium/memory 1330 is configured to store instructions (e.g., computer-executable code), that when executed by the one or more processors 1310, cause the one or more processors 1310 to perform the method 1200 described with respect to FIG. 12, or any aspect related to it, including any operations described in relation to FIG. 12. Note that reference to a processor performing a function of communications device 1300 may include one or more processors performing that function of communications device 1300, such as in a distributed fashion.

In the depicted example, computer-readable medium/memory 1330 stores code (e.g., executable instructions), including code for sending 1335, code for communicating 1340, and code for performing 1345. Processing of the code 1335-1345 may enable and cause the communications device 1300 to perform the method 1200 described with respect to FIG. 12, or any aspect related to it. For example, in some aspects, code for sending 1335 includes code for sending a SDAP control PDU comprising an indication of a QoS flow level congestion. In some aspects, code for communicating 1340 includes code for communicating with a second wireless communications device in accordance with the indication of the QoS flow level congestion.

The one or more processors 1310 include circuitry configured to implement (e.g., execute) the code stored in the computer-readable medium/memory 1330, including circuitry for sending 1315, circuitry for communicating 1320, and circuitry for performing 1325. Processing with circuitry 1315-1325 may enable and cause the communications device 1300 to perform the method 1200 described with respect to FIG. 12, or any aspect related to it. For example, in some aspects, circuitry for sending 1315 includes circuitry for sending a SDAP control PDU comprising an indication of a QoS flow level congestion. In some aspects, circuitry for communicating 1320 includes circuitry for communicating with a second wireless communications device in accordance with the indication of the QoS flow level congestion.

More generally, means for communicating, transmitting, sending or outputting for transmission may include the one or more transceivers 324, one or more antennas 322, and/or processing system 316 of the UE 304 illustrated in FIG. 3, transceiver 1355, and/or antenna 1360, of the communications device 1300 in FIG. 13; and/or one or more processors 1310 of the communications device 1300 in FIG. 13. Means for communicating, receiving or obtaining may include the one or more transceivers 324, one or more antennas 322, and/or processing system 316 of the UE 304 illustrated in FIG. 3, transceiver 1355, and/or antenna 1360, of the communications device 1300 in FIG. 13; and/or one or more processors 1310 of the communications device 1300 in FIG. 13.

### Example Clauses

Implementation examples are described in the following numbered clauses:
Clause 1: A method of wireless communications by a first wireless communications device, comprising: sending a SDAP control PDU comprising an indication of a QoS flow level congestion; and communicating with a second wireless communications device in accordance with the indication of the QoS flow level congestion.
Clause 2: The method of Clause 1, wherein communicating with the second wireless communications device in accordance with the indication of the QoS flow level congestion comprises performing a communication in accordance with an increased size of a grant without a modification in a mapping between a QoS flow of the communication and a radio bearer.
Clause 3: The method of any one of Clauses 1-2, wherein communicating with the second wireless communications device in accordance with the indication of the QoS flow level congestion comprises performing a communication in accordance with a modified mapping between a QoS flow of the communication and a radio bearer, the modified mapping being in accordance with a static QoS mechanism or a dynamic QoS mechanism.
Clause 4: The method of Clause 3, wherein the static QoS mechanism comprises a RRC signaling mechanism.
Clause 5: The method of Clause 3, wherein the dynamic QoS mechanism comprises a reflective QoS mechanism.
Clause 6: The method of any one of Clauses 1-5, wherein communicating with the second wireless communications device in accordance with the indication of the QoS flow level congestion comprises performing a communication in accordance with a modified logical channel configuration for a grant, the grant being based on one or more logical channel parameters.
Clause 7: The method of any one of Clauses 1-6, wherein communicating with the second wireless communications device in accordance with the indication of the QoS flow level congestion comprises performing a communication in accordance with one or more modified configuration parameters at one or more of: a PDCP layer, a RLC layer, a MAC layer, or a PHY layer.
Clause 8: The method of any one of Clauses 1-7, wherein the first wireless communications device comprises a user equipment, and the second wireless communications device comprises a network entity.
Clause 9: The method of any one of Clauses 1-8, wherein the first wireless communications device comprises a network entity, and the second wireless communications device comprises a user equipment.
Clause 10: The method of any one of Clauses 1-9, wherein the indication of the QoS flow level congestion comprises a congestion indication for a QFI, wherein the congestion indication is within a defined field of the SDAP control PDU.
Clause 11: The method of any one of Clauses 1-10, wherein the indication of the QoS flow level congestion comprises an explicit indication of a QoS flow rate adaptation value for a QFI.
Clause 12: The method of any one of Clauses 1-11, wherein the indication of the QoS flow level congestion comprises an index value corresponding to a QoS flow rate adaptation value for a QFI.
Clause 13: The method of any one of Clauses 1-12, wherein communicating with the second wireless communications device in accordance with the indication of the QoS flow level congestion comprises performing a communication with one or more data packets dropped for a QoS flow associated with the QoS flow level congestion, the one or more data packets dropped based on a significance indication comprising a relative level of significance of the one or more data packets compared to other data packets for the QoS flow or for multiple QoS flows, the relative level of significance of the one or more data packets based on application level information.
Clause 14: One or more apparatuses, comprising: one or more memories comprising executable instructions; and one or more processors configured to execute the executable instructions and cause the one or more apparatuses to perform a method in accordance with any one of Clauses 1-13.
Clause 15: One or more apparatuses configured for wireless communications, comprising: one or more memories; and one or more processors, coupled to the one or more memories, configured to cause the one or more apparatuses to perform a method in accordance with any one of Clauses 1-13.
Clause 16: One or more apparatuses configured for wireless communications, comprising: one or more memories; and one or more processors, coupled to the one or more memories, configured to perform a method in accordance with any one of Clauses 1-13.
Clause 17: One or more apparatuses, comprising means for performing a method in accordance with any one of Clauses 1-13.
Clause 18: One or more non-transitory computer-readable media comprising executable instructions that, when executed by one or more processors of one or more apparatuses, cause the one or more apparatuses to perform a method in accordance with any one of Clauses 1-13.
Clause 19: One or more computer program products embodied on one or more computer-readable storage media comprising code for performing a method in accordance with any one of Clauses 1-13.
Clause 20: One or more apparatuses configured for wireless communications, comprising: a processing system that includes one or more processors and one or more memories coupled with the one or more processors, the processing system configured to cause the one or more apparatuses to perform a method in accordance with any one of Clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a first wireless communications device to:
send a service data adaptation protocol (SDAP) control protocol data unit (PDU) comprising an indication of a quality of service (QoS) flow level congestion; and
communicate with a second wireless communications device in accordance with the indication of the QoS flow level congestion.

2. The apparatus of claim 1, wherein to cause the first wireless communications device to communicate with the second wireless communications device in accordance with the indication of the QoS flow level congestion, the processing system is configured to cause the first wireless communications device to perform a communication in accordance with an increased size of a grant without a modification in a mapping between a QoS flow of the communication and a radio bearer.

3. The apparatus of claim 1, wherein to cause the first wireless communications device to communicate with the second wireless communications device in accordance with the indication of the QoS flow level congestion, the processing system is configured to cause the first wireless communications device to perform a communication in accordance with a modified mapping between a QoS flow of the communication and a radio bearer, the modified mapping being in accordance with a static QoS mechanism or a dynamic QoS mechanism.

4. The apparatus of claim 3, wherein the static QoS mechanism comprises a radio resource control (RRC) signaling mechanism.

5. The apparatus of claim 3, wherein the dynamic QoS mechanism comprises a reflective QoS mechanism.

6. The apparatus of claim 1, wherein to cause the first wireless communications device to communicate with the second wireless communications device in accordance with the indication of the QoS flow level congestion, the processing system is configured to cause the first wireless communications device to perform a communication in accordance with a modified logical channel configuration for a grant, the grant being based on one or more logical channel parameters.

7. The apparatus of claim 1, wherein to cause the first wireless communications device to communicate with the second wireless communications device in accordance with the indication of the QoS flow level congestion, the processing system is configured to cause the first wireless communications device to perform a communication in accordance with one or more modified configuration parameters at one or more of:
a packet data convergence protocol (PDCP) layer,
a radio link control (RLC) layer,
a medium access control (MAC) layer, or
a physical (PHY) layer.

8. The apparatus of claim 1, wherein the first wireless communications device comprises a user equipment, and the second wireless communications device comprises a network entity.

9. The apparatus of claim 1, wherein the first wireless communications device comprises a network entity, and the second wireless communications device comprises a user equipment.

10. The apparatus of claim 1, wherein the indication of the QoS flow level congestion comprises a congestion indication for a QoS flow identifier (QFI), wherein the congestion indication is within a defined field of the SDAP control PDU.

11. The apparatus of claim 1, wherein the indication of the QoS flow level congestion comprises an explicit indication of a QoS flow rate adaptation value for a QoS flow identifier (QFI).

12. The apparatus of claim 1, wherein the indication of the QoS flow level congestion comprises an index value corresponding to a QoS flow rate adaptation value for a QoS flow identifier (QFI).

13. The apparatus of claim 1, wherein to cause the first wireless communications device to communicate with the second wireless communications device in accordance with the indication of the QoS flow level congestion, the processing system is configured to cause the first wireless communications device to perform a communication with one or more data packets dropped for a QoS flow associated with the QoS flow level congestion, the one or more data packets dropped based on a significance indication comprising a relative level of significance of the one or more data packets compared to other data packets for the QoS flow or for multiple QoS flows, the relative level of significance of the one or more data packets based on application level information.

14. A method of wireless communications by a first wireless communications device, comprising:
sending a service data adaptation protocol (SDAP) control protocol data unit (PDU) comprising an indication of a quality of service (QoS) flow level congestion; and
communicating with a second wireless communications device in accordance with the indication of the QoS flow level congestion.

15. The method of claim 14, wherein communicating with the second wireless communications device in accordance with the indication of the QoS flow level congestion comprises performing a communication in accordance with an increased size of a grant without a modification in a mapping between a QoS flow of the communication and a radio bearer.

16. The method of claim 14, wherein communicating with the second wireless communications device in accordance with the indication of the QoS flow level congestion comprises performing a communication in accordance with a modified mapping between a QoS flow of the communication and a radio bearer, the modified mapping being in accordance with a static QoS mechanism or a dynamic QoS mechanism, wherein the static QoS mechanism comprises a radio resource control (RRC) signaling mechanism, wherein the dynamic QoS mechanism comprises a reflective QoS mechanism.

17. The method of claim 14, wherein communicating with the second wireless communications device in accordance with the indication of the QoS flow level congestion comprises performing a communication in accordance with a modified logical channel configuration for a grant, the grant being based on one or more logical channel parameters.

18. The method of claim 14, wherein communicating with the second wireless communications device in accordance with the indication of the QoS flow level congestion comprises performing a communication in accordance with one or more modified configuration parameters at one or more of:
a packet data convergence protocol (PDCP) layer,
a radio link control (RLC) layer,
a medium access control (MAC) layer, or
a physical (PHY) layer.

19. The method of claim 14, wherein the indication of the QoS flow level congestion comprises a congestion indication for a QoS flow identifier (QFI), wherein the congestion indication is within a defined field of the SDAP control PDU, wherein the indication of the QoS flow level congestion further comprises an explicit indication of a QoS flow rate adaptation value for the QFI or an index value corresponding to the QoS flow rate adaptation value for the QFI.

20. An apparatus for wireless communications by a first wireless communications device, comprising:
means for sending a service data adaptation protocol (SDAP) control protocol data unit (PDU) comprising an indication of a quality of service (QoS) flow level congestion; and
means for communicating with a second wireless communications device in accordance with the indication of the QoS flow level congestion.
